(19) United States
(12) Patent Application Publication
(10) Pub. No.: US 2025/0217933 A1
(43) Pub. Date: Jul. 3, 2025

(54) Devices, Systems, and Methods for Biological Sample Imaging

(71) Applicant: IDEXX Laboratories, Inc., Westbrook, ME (US)

(72) Inventors: Jeremy Hammond, Westbrook, ME (US); David Steines, Westbrook, ME (US)

(21) Appl. No.: 19/002,845

(22) Filed: Dec. 27, 2024

Related U.S. Application Data
(60) Provisional application No. 63/616,341, filed on Dec. 29, 2023.

(51) Int. Cl. G06T 5/50; G06T 5/60; G06V 10/762; G06V 10/764; G06V 10/774; G06V 20/69

(52) U.S. Cl. CPC G06T 5/50; G06T 5/60; G06V 10/762; G06V 10/764; G06V 10/774; G06V 20/698; G06T 2207/10056; G06T 2207/20081; G06T 2207/20084; G06T 2207/20212; G06T 2207/30024

(57) ABSTRACT

A computer-implemented method for interrogating a sample with a microscopy device is disclosed. The computer-implemented method comprises capturing, by a microscopy device, one or more images of a biological sample. The computer-implemented method also comprises inputting the one or more images into one or more machine learning models and identifying, in the one or more images of the biological sample, via the one or more machine learning models, a plurality of images of a cell type. The computer-implemented method further comprises selecting, by the one or more machine learning models, a subset of the plurality of images of the cell type for transmission. The computer-implemented method also comprises, in response to selecting the subset of the plurality of images of the cell type for transmission, generating, via the one or more machine learning models, one or more composite images, wherein the one or more composite images comprise a representation of at least one characteristic of the subset of the plurality of the images of the cell type, and transmitting, to a computing device, the composite image.

### CROSS-REFERENCE TO RELATED APPLICATIONS

This application claims the benefit of co-pending U.S. Provisional Patent Application Ser. No. 63/616,341, filed Dec. 29, 2023, which is hereby incorporated by reference its entirety.

### FIELD OF THE DISCLOSURE

The present disclosure involves devices, systems, and methods for biological sample imaging. Namely, devices, systems, and methods of the disclosure capture one or more images of a biological sample from an imaging sensor of a microscopy analyzer and determine a subset of images of the one or more images based on a determined cell type. Once the subset of images is determined, the present disclosure involves implementing one or more machine learning models to analyze the subset of images and perform one or more computational actions, including generating composite images of the subset of images.

### BACKGROUND

Sample interrogation and analysis can be conducted utilizing a variety of different methods, including dry samples and wet samples.

### SUMMARY

Historically, biological samples have been examined under a microscope by preparing a dry sample of the biological sample prior to viewing and/or otherwise analyzing the dried sample underneath a microscope. These dry samples are typically manually prepared by a technician using a smear technique on a glass slide. To increase the accuracy of assay test results, it is desirable to, prior to analysis, ensure that the sample is not altered (e.g., via physical interaction with a technician).

When technicians manually prepare the dry sample for testing, the sample is often physically altered and distorted, often by a technician who places a fluid sample on a slide, then manually spreads the sample across the slide (often referred to as “smearing” the sample) and allowing the sample to dry prior to analysis under the microscope. In doing so, the composition, consistency, physical attributes, homogeneity, and other characteristics of the components of the sample throughout the prepared dried sample may be inconsistent and/or inaccurate. Further, because the process of preparing the dried sample is performed by a variety of different technicians in different clinical settings, the variability of the prepared dried samples is substantial, which in turn can also impact the accuracy and precision of any analytical results for which the dried sample may be used. Accordingly, manual preparations of the samples are subject to variability between preparations and/or operators and, thus, degrade the accuracy and precision of any associated analytical results.

Additionally, historically, analysis of images of biological samples has been done by a technician, requiring a technician to manually determine characteristics of the samples. During such analysis, a technician is limited by the quality of the images of the biological samples. For example, a low-resolution or a low-contrast image of a biological sample may hinder a technician's ability to analyze relevant characteristics of the biological sample. Furthermore, this analysis is often time-intensive and varies from technician to technician, as do the results of these different analyses.

In an example, a computer-implemented method is described for analyzing a sample. The computer-implemented method comprises capturing, by a microscopy device, one or more images of a biological sample. The computer-implemented method also comprises inputting the one or more images into one or more machine learning models and identifying, in the one or more images of the biological sample, via the one or more machine learning models, a plurality of images of a cell type. The computer-implemented method further comprises selecting, by the one or more machine learning models, a subset of the plurality of images of the cell type for transmission. The computer-implemented method also comprises, in response to selecting the subset of the plurality of images of the cell type for transmission, generating, via the one or more machine learning models, one or more composite images, wherein the one or more composite images comprise a representation of at least one characteristic of the subset of the plurality of the images of the cell type, and transmitting, to a computing device, the composite image.

In another example, a non-transitory computer-readable medium is described, having instructions stored thereon, wherein the instructions, when executed by one or more processors, cause the one or more processors to perform a set of operations. The set of operations comprises capturing, by a microscopy device, one or more images of a biological sample. The set of instructions also comprises inputting the one or more images into one or more machine learning models and identifying, in the one or more images of the biological sample, via the one or more machine learning models, a plurality of images of a cell type. The set of instructions further comprises selecting, by the one or more machine learning models, a subset of the plurality of images of the cell type for transmission. The set of instructions also comprises, in response to selecting the subset of the plurality of images of the cell type for transmission, generating, via the one or more machine learning models, one or more composite images, wherein the one or more composite images comprise a representation of at least one characteristic of the subset of the plurality of the images of the cell type, and transmitting, to a computing device, the composite image.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2 illustrates a microscopy analyzer, according to an example embodiment.

FIG. 3 is an example computing system configured for use with the microscopy analyzer of FIG. 2 and a mobile computing device, according to an example embodiment.

FIG. 4 illustrates a computer-implemented method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices, systems, and methods for interrogating a biological sample by capturing and transmitting images of the biological sample using a microscopy analyzer.

In an example embodiment, this interrogation may include capturing one or more images that are used in competitive immunoassays for detection of antibody in the sample. A competitive immunoassay may be carried out in the following illustrative manner. A sample, from an animal's body fluid, potentially containing an antibody of interest that is specific for an antigen, is contacted with the antigen attached to the particle and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive assay, a sample, an animal's body fluid, potentially containing an analyte, is contacted with the analyte conjugated to a detectable label and with an anti-analyte antibody attached to the particle. The antigen in the sample competes with analyte conjugated to the label for binding to the antibody attached to the particle. The amount of the label associated with the particles can then be determined after separating unbound antigen and label. The signal obtained is inversely related to the amount of analyte present in the sample.

Antibodies, antigens, and other binding members may be attached to the particle or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the particles and methods of the disclosure may be used in other receptor binding assays, including nucleic acid hybridization assays that rely on immobilization of one or more assay components to a solid phase.

Historically, assays and microscopic analysis using dry samples are often rife with issues. For example, as samples are dried out, the samples can warp or distort and become non-uniform. Additionally, during preparation, technicians often use chemicals to stain elements of the sample (e.g., Wright-Giemsa stain, Diff Quick, Gram stain, etc.), and the age and quality of these stains can have a significant impact on the microscopic presentation, potentially impacting the way the sample and/or the stain presents during analysis (e.g., presents a different color than expected, different intensity than expected, etc.). Further, it is common to find bacterial contamination in these stains, which may then transfer bacteria into the sample, thus confusing if the sample had bacterial contamination. Therefore, the quality of the dry sample is dependent on the quality and age of the chemicals, as well as the drying time and technique. In further examples, dry samples are prepared using a smear technique, which can alter, and even destroy, the cells. Digital images of dry samples are, thus, less accurate, low-contrast, and time-intensive. For these reasons, it may be desirable to interrogate fluidic samples. Similarly, it may be desirable to modify lighting conditions and image contrast of images captured of dry samples in order to better analyze the samples.

Further, assays and microscopic analysis using fluidic samples often have issues as well. These issues include being unable to use well-known stains on glass slides in connection with fluidic samples and difficulties imaging fluidic samples because of unintended movement of the fluid samples as the slide is transported and/or otherwise positioned on the microscope. In another example, during imaging, there may be issues achieving suitable lighting for imaging the fluid sample. To help address these issues, an intensity of a light source used in imaging the fluid sample may be modified based on the type of stain and the stain intensity used with the fluid sample. In another example, during imaging, there may be issues identifying characteristics of the fluid sample. To help address this issue, captured images may be enhanced or modified.

Further still, assays and microscopic analysis using biological fluid samples, such as blood, urine, saliva, body cavity fluids, fine needle aspirates, fecal samples, lavage samples, or ear wax, are significantly more difficult because biological fluids are sensitive to contamination, prone to coagulation, and can be altered during smear preparation. Additionally, biological fluid samples, such as blood and saliva, present unique challenges because of rapid deoxygenation during analysis, as well as potential temperature effects on the biological fluid samples. Further, in some examples, it is desired to analyze wet mount samples in order to preserve bacteria, parasites, cancerous cells, proteins, and other components of the biological fluid samples to ensure accurate diagnosis and analysis. In another example, biological fluid samples may require mixing with a stain to improve accuracy and consistency of assay results. To help address this issue, the biological fluid sample can be mixed with a stain configured to react in an aqueous solution, forming a mixed fluid sample.

Particularly, assays and microscopic analysis using biological fluid samples or dry samples may be inaccurate due to inconsistencies with the stain used with the samples, including contamination, lower efficacy due to use, age, or evaporation, or other common issues. Further, when an intensity setting of light source is modified, or a focal setting of an objective lens is modified, an operator of the microscopy analyzer may encounter problems with the contrast or other image quality features of a captured image of a sample. Particularly, an operator may encounter problems identifying characteristics of the mixed fluid sample, whether because of stain intensity, image contrast, or human error. To help address these issues, a computer-implemented method for interrogating a biological sample can include identifying, by one or more machine learning models, in one or more images of the biological sample, a plurality of images of a cell type, and selecting, by the one or more machine learning models, a subset of the plurality of images of the cell type. In some examples, the computer-implemented method can include applying a cell classifier to discriminate based on the type of cell or type of object in an image, to alter which features will be accentuated in captured images. In example embodiments, these classifiers may use some or all channels of data from the microscopy analyzer to provide data and information to compile a representation of one or more characteristics presented in the image (e.g., an 8-dimensional image of the cells).

To do so, however, digital microscopy approaches generate significant volumes of data, particularly when multiple images are captured at several locations and depth values for focusing and for cell evaluation or when multiple optical configurations are employed including various illumination wavelengths, optical filters, or fluorescent techniques. These large data sets can significantly delay and hinder analysis of the samples. To help address these issues, machine learning models can identify partial fields of view to reduce parts of images that are not significant to one or more portions of analysis, such as background or areas of the slide that do not contain cells. In a further aspect, in examples, these machine learning models can further choose the correct volume and specific cell examples from the one or more portions of the image and/or fields of view to reduce the file size and transfer time of the captured images. To further help address these issues, in response to selecting these subsets of the plurality of images of the cell type, the computer-implemented method may further include generating one or more composite images, wherein the one or more composite images comprise a representation of at least one characteristic of the subset of the plurality of images of the cell type. In some examples, the composite images may include one or more mosaic images. In some examples, the composite images may be of a particular size and/or cell dimensions, including: 1×5 cells, 2×5 cells, 3×5 cells, 4×5 cells, 5×5 cells, 6×5 cells, 7×5 cells, 1×1 cells, 2×2 cells, 3×3 cells, 4×4 cells, 6×6 cells, and 7×7 cells, among other possibilities.

Further, if the machine learning model attempts to identify a cell type or characteristics of a biological sample, and the machine learning model has not identified that cell type or characteristic before, the characteristic or cell type may not be accurately identified. In doing so, the machine learning model may expend significant time and/or computational resources attempting to identify the cell type or characteristic. To help address these issues, the machine learning model may be trained with training images that share one or more characteristics with the images captured by the imaging sensor. In examples, this training may be done by inputting one or more training images into the machine learning model, using the machine learning model to predict an outcome of a determined condition of the training images, such as the location of a characteristic, and comparing the outcome to the characteristic of the one or more training images. Based on the comparison, the machine learning model can be adjusted. In some examples, the machine learning model may include at least one algorithm, the algorithm including variables which are assigned different weights. Based on the comparison of the training images to the predicted outcomes, the weights in the algorithm may be adjusted either higher or lower. In some examples, training can include supervised learning, semi-supervised learning, reinforcement learning, or unsupervised learning.

In some examples, the images captured by the imaging sensor may be difficult to interpret because of contrast levels being too high or too low, the images being out of focus, the saturation of colors being too high or too low, among others. In some examples, the images captured by the imaging sensor may not capture the entirety of an area of interest. Therefore, in order to capture all of the necessary data to properly interpret the entirety of the sample, a technician may need to capture significant volumes of data, which can be impractical to transmit and time consuming to analyze. To help address these issues, the machine learning model can determine a subset of images before outputting the images to a graphical user interface. In some examples, the machine learning model may determine the subset of images based on extracting areas of captured images only where one or more cells and/or one or more types of cells are present in the captured image. In some examples, the machine learning model may further determine the subset of images based on identifying clusters of the captured images that have one or more similar characteristics, such as a percentage of area that contains cells of a certain cell size or a density of cells of a certain cell size. In a further aspect, in examples, the machine learning model may also identify specific cells and/or predetermined features of the sample and present only those specific cells and/or predetermined features. In another example, if there are one or more common representations of specific cells and/or predetermined features in the sample, then the machine learning model can choose to share some images of those specific cells and/or predetermined features and leave out other specific cells and/or features (e.g., because they do not add additional value for analysis). To further help address these issues, the machine learning model may also create a composite image from the subset of images. The machine learning model may further calculate summary statistics about the cells in captured images to provide additional quantitative data in place of including more images of the cells, allowing for faster interpretation and analysis of the sample. For example, if one or more areas of cells are identified in a sample, then statistics and/or graphical representations of the concentration of those cells in one or more areas of the sample may be presented, such that a user can understand one or more characteristics of the sample (e.g., that the sample was full of the particular cells or features) based on only a few images and/or portions of one or more images. Other examples are possible.

In some examples, to help address the above issues, the computer-implemented method may include identifying, in the one or more images of the biological sample, via the one or more machine learning models, a first plurality of images of a first cell type and a second plurality of images of a second cell type. The computer-implemented method may then further include selecting a first subset of the plurality of images of the first cell type and a second subset of the plurality of the images of the second cell type and generating, via the one or more machine learning models, a first composite image and a second composite image for transmission.

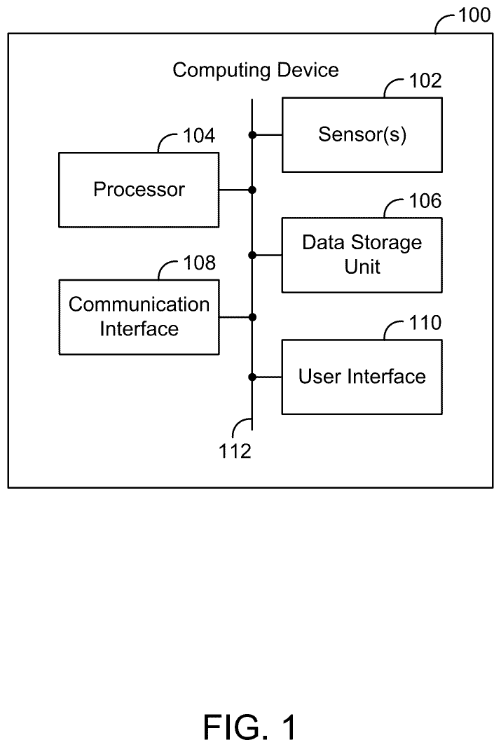

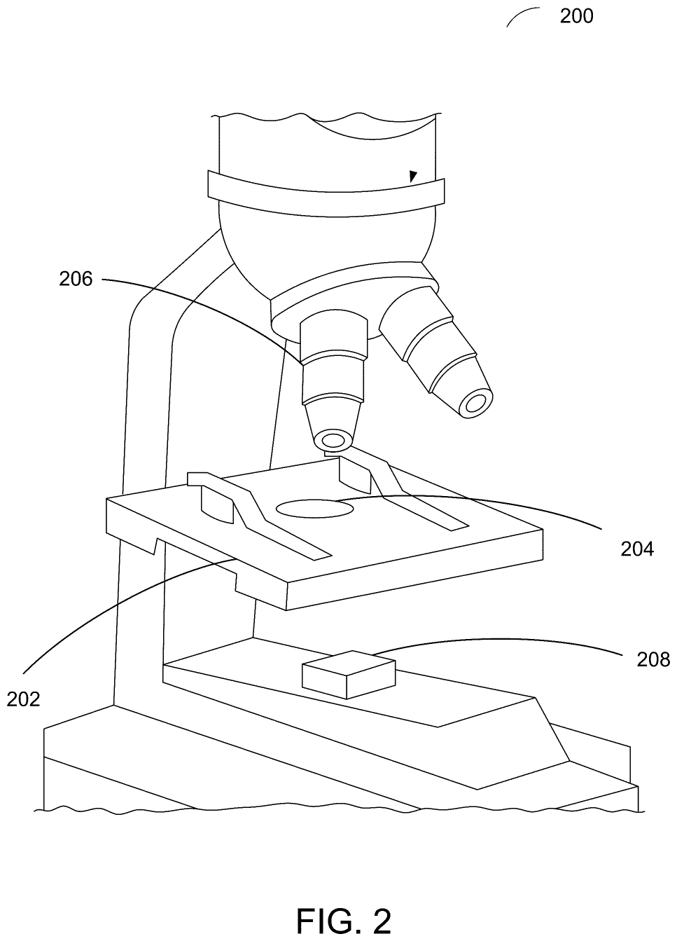

Referring now to the figures, FIG. 1 is a simplified block diagram of an example computing device 100 of a system (e.g., those illustrated in FIGS. 2A-2B, described in further detail below). Computing device 100 can perform various acts and/or functions, such as those described in this disclosure. Computing device 100 can include various components, such as sensors 102, processor 104, data storage unit 106, communication interface 108, and/or user interface 110. These components can be connected to each other (or to another device, system, or other entity) via connection mechanism 112.

The sensor 102 can include sensors now known or later developed, including but not limited to an imaging sensor, a camera, a thermal imager, photodiode sensors, a proximity sensor (e.g., a sensor and/or communication protocol to determine the proximity of a slide of a microscopy analyzer to an objective lens) and/or a combination of these sensors, among other possibilities. These sensors may include zoom lenses, monochromatic sensors, color sensors, digital sensors, electromagnetic sensors, and/or a combination of these, among other possibilities.

Processor 104 can include a general-purpose processor (e.g., a microprocessor) and/or a special-purpose processor (e.g., a digital signal processor (DSP)).

Data storage unit 106 can include one or more volatile, non-volatile, removable, and/or non-removable storage components, such as magnetic, optical, or flash storage, and/or can be integrated in whole or in part with processor 104. Further, data storage unit 106 can take the form of a non-transitory computer-readable storage medium, having stored thereon program instructions (e.g., compiled or non-compiled program logic and/or machine code) that, when executed by processor 104, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 108 and/or user interface 110. Data storage unit 106 can also store other types of data, such as those types described in this disclosure.

Communication interface 108 can allow computing device 100 to connect to and/or communicate with another other entity according to one or more protocols. In one example, communication interface 108 can be a wired interface, such as an Ethernet interface or a high-definition serial-digital-interface (HD-SDI). In another example, communication interface 108 can be a wireless interface, such as a cellular or WI FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

User interface 110 can facilitate interaction between computing device 100 and a user of computing device 100, if applicable. As such, user interface 110 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 110 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2, an example microscopy analyzer 200 is disclosed, which includes a platform 202, a slide receiving area 204, an objective lens 206, and a brightfield light source 208 opposite from the objective lens 206, according to an example embodiment. The platform 202 includes the slide receiving area 204, and in some embodiments, the slide receiving area 204 is configured to receive a slide containing a wet sample or a dry sample. The brightfield light source 208 shines light through the slide receiving area 204, allowing a user to observe a sample placed in the slide receiving area 204 via the objective lens 206. In some examples, a plurality of sensors may be coupled to the objective lens 206, according to example embodiments. Although not illustrated, in some embodiments, the microscopy analyzer may be a standard microscope having an objective lens disposed above a sample and a light source disposed below the sample or an inverted microscope having an objective lens on disposed below a sample and a light source disposed above the sample.

The microscopy analyzer 200 may interrogate, via an objective lens 206, a sample. In some embodiments, the microscopy analyzer 200 is part of a sample interrogation system including a computing device such as computing device 100. As described above, a computing device 100 can be implemented as a controller, and a user of the controller can use the controller to interrogate the sample. The microscopy analyzer 200 and the objective lens 206 may be communicably coupled with a controller, such as computing device 100, and may communicate with the controller by way of a wired connection, a wireless connection, or a combination thereof.

In examples, the controller can execute a program that causes the microscopy analyzer 200 and sensors coupled to the objective lens 206 to perform a series of interrogation events by way of a non-transitory computer-readable medium having stored program instructions. These program instructions include, capturing, by an imaging sensor coupled to the objective lens 206, one or more first images of the sample, modifying an intensity of a light source, such as the brightfield light source 208, based at least on the determined stain intensity, in response to modifying the intensity of the light source, capturing one or more second images from the imaging sensor coupled to the objective lens 206, inputting the one or more second images into one or more machine learning models, identifying, via the one or more machine learning models, one or more characteristics of the sample in the one or more first images and the one or more second images, and transmitting instructions that cause a graphical user interface, such as user interface 110, to display an indication of the identified characteristics.

In some embodiments, microscopy analyzer 200 may receive a slide, which may comprise a pair of glass slides that have a fluid sample between the two slides. In other examples, the slide may be made from other and/or additional materials, including one or more of the following: fused silica, quartz, glass with an enamel coating, or slides with resin coatings. Such materials are described for the purposes of illustrating example embodiments. In further examples, may contain one or more additional features, including one or more cavities in which a fluid sample may be disposed and analyzed (e.g., a plastic slide configured to receive a sample prepared with a stain.).

In a further embodiment, the sample may include one or more of blood, urine, saliva, earwax, sperm, or any other biological sample that can be analyzed with a microscopy analyzer. In some embodiments, the sample also includes a stain, such as methylene blue, new methylene blue, acridine orange, and methanol-based wright-giemsa stains or diff quik.

In some examples, the sample includes blood cells, epithelial cells, crystals, mesenchymal cells, round cells, solid pieces of earwax, bacteria, parasites, fungi, single-cell organisms, and other objects of interest. As described above, a computing device 100 can be implemented as a controller, and a user of the controller can use the controller to control the capturing of one or more images of the sample, as well as process the plurality of images to generate and/or annotate a composite image of the plurality of images. In examples, the controller can execute a program that identifies a characteristic of the sample in the one or more images. In some examples, the controller can execute a program that adjusts a contrast level of the one or more first images or the one or more second images based on a normalization of the one or more first images or the one or more second images. In further examples, adjusting the contrast includes using an automatic gain control feature.

In examples, the controller can execute a program that causes the controller and/or components operating therewith (e.g., a camera) to perform a series of actions by way of a non-transitory computer-readable medium having stored program instructions.

In example embodiments, the controller may determine a characteristic of a fluid sample by performing one or more of a pixel density and/or gradient analysis of the one or more images captured by the controller. In some example embodiments, the characteristics of the one or more images may present a different contrast and/or pixel density compared the stain used in preparation of the sample. In examples, the stain of the fluid sample may present a different contrast of the characteristics of the fluid sample.

Once one or more images have been captured, further analysis may be undertaken on the images to alter the images or to determine one or more characteristics of the fluid sample. In example embodiments, a user may want to enhance one or more features of the images, including a saturation enhancement, a brightness enhancement, a contrast enhancement, and a focal setting enhancement. In some examples, a user may use the controller to control the enhancement of the one or more image. To do so, the user may select to use one or more programs executing a variety of automated protocols, including one or more enhancement protocols. In example embodiments, the controller may use one or more algorithms and/or protocols to detect a particle in the composite image, based at least in part on detecting an edge and/or another feature of the particle in the composite image, thereby determining a presence of at least one particle in the composite image. Other examples, including the use of other image processing and/or machine learning and artificial intelligence algorithms, are possible. For example, one or more machine learning models may comprise a deep learning model and/or image pixel and/or gradient analysis models.

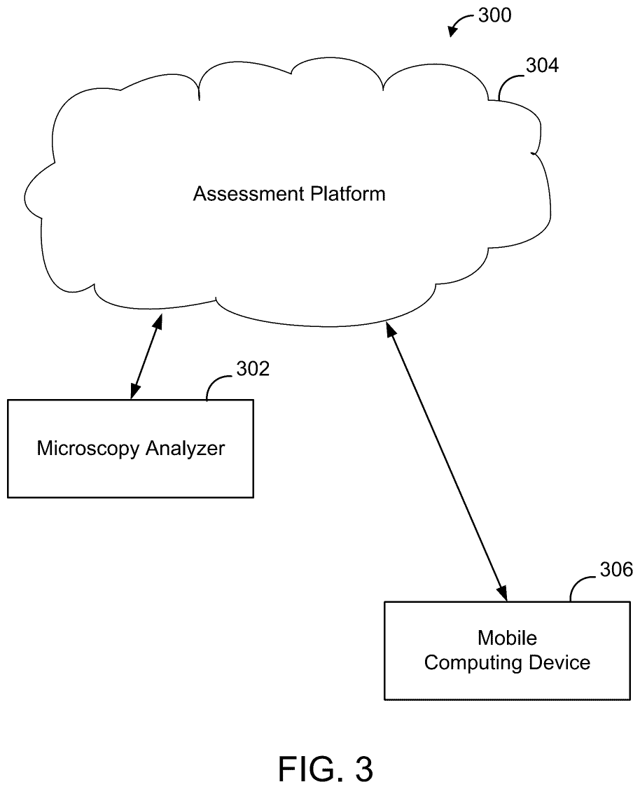

FIG. 3 is a simplified block diagram of an example computing system 300. The computing system 300 can perform various acts and/or functions related to the concepts detailed herein. In this disclosure, the term “computing system” means a system that includes at least one computing device. In some instances, a computing system can include one or more other computing systems, including one or more computing systems controlled by a user, a clinician, different independent entities, and/or some combination thereof.

It should also be readily understood that computing device 100, microscopy analyzer 200, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the computing system 300 can include various components, such as microscopy analyzer 302, cloud-based assessment platform 304, and mobile computing device 306, each of which can be implemented as a computing system.

The computing system 300 can also include connection mechanisms (shown here as lines with arrows at each end (i.e., “double arrows”), which connect microscopy analyzer 302, cloud-based assessment platform 304, and mobile computing device 306, and may do so in a number of ways (e.g., a wired mechanism, wireless mechanisms and communication protocols, etc.).

In practice, the computing system 300 is likely to include many of some or all of the example components described above, such as microscopy analyzer 302, cloud-based assessment platform 304, and mobile computing device 306, which can allow many users to communicate and/or interact with the assessment platform, the assessment platform to communicate with many users, and so on.

The computing system 300 and/or components thereof can perform various acts and/or functions (many of which are described above). Examples of these and related features will now be described in further detail.

Within computing system 300, assessment platform 304 may collect data from a number of sources.

In one example, assessment platform 304 may collect data from a database of images related to assays and microscopic analyses of samples, including one or more images of samples. The images may be uploaded to the assessment platform 304 and characteristics of the images may be identified and/or output to a mobile computing device, such as mobile computing device 306.

In another example, assessment platform 304 may collect data from one or more sensors communicably coupled to the microscopy analyzer 302, such as an imaging sensor, concerning a particular sample. In such examples, the assessment platform 304 may identify a characteristic of the sample and utilize the identified characteristic to inform further analysis of a particular captured image and/or one or more images that share one or more characteristics with the captured image. For example, in example embodiments, the assessment platform 304 may use one or more machine learning models to determine a subset of images in the captured image based on extracting areas of captured images where one or more cells and/or one or more types of cells are present in the captured image. In some examples, the assessment platform 304 may use one or more machine learning models to determine this subset of images based on identifying clusters within the captured images that have one or more similar characteristics, such as a percentage of area that contains cells of a certain cell size or a density of cells of a certain cell size. To do so, in examples, the assessment platform 304 may determine a characteristic of the sample by utilizing one or more of: (i) an artificial neural network, (ii) a support vector machine, (iii) a regression tree, or (iv) an ensemble of regression trees. Other examples are possible.

In examples, the assessment platform 304 may use one or more machine learning models to create a representation of these one or more characteristics, including one or more composite images that represent the identified characteristics of the subset of images. In examples, the assessment platform 304 may use one or more machine learning models to further calculate one or more summary statistics about the cells and/or cell types in the captured images. By doing so, in examples, the assessment platform 304 may use one or more machine learning models to provide additional quantitative data in addition to and/or in place of the one or more images of the cells, allowing for faster interpretation and analysis of the sample.

In some examples, prior to transmitting the one or more composite images and/or the statistical data, the assessment platform 304 may encrypt and/or compress the one or more composite images and the statistical data, allowing for faster transmission (and thus faster interpretation and analysis) of the sample. To do so, in examples, the assessment platform 304 may utilize one or more encryption protocols, including one or more encryption algorithms and corresponding keys (which may be symmetrical or asymmetrical), as well as one or more compression protocols, including arithmetic coding and/or one or more machine learning compression algorithms and/or techniques, among other possibilities.

In some examples, images that are captured by the microscopy analyzer 302 can be stored within a memory, such as a memory of microscopy analyzer 302 (which may implement one or more components of computing device 100), cloud-based memory of assessment platform 304, or a memory of mobile computing device 306 to be subsequently analyzed.

In some examples, assessment platform 304 may collect data from a sensor of the microscopy analyzer 302 and input data from a user of the mobile computing device 306 or a user of the microscopy analyzer 302. In one example, assessment platform 304 may transmit instructions to cause a graphical user interface to display a graphical indication of an identified characteristic along with the input data received from a user of the mobile computing device 306 or a user of the microscopy analyzer 302.

In some examples, assessment platform 304 may collect data in the form of images from an imaging sensor of microscopy analyzer 302, taken at different z-depths, in conjunction with a brightfield light source and images from an imaging sensor of microscopy analyzer 302, taken at different z-depths, in conjunction with a fluorescent light source. Assessment platform 304 may then transmit instructions to cause a graphical user interface to display a graphical indication of a composite image generated from images taken with the brightfield light source and images taken with the fluorescent light source.

In some examples, assessment platform 304 may collect data in the form of images of a first partial field of view of the biological sample based on a first determined characteristic of the biological sample and a second partial field of view of the biological sample based on a second determined characteristic of the biological sample. Assessment platform 304 may then transmit instructions to cause a graphical user interface to display a graphical indication of a composite image using images taken from the first and second partial fields of view of the biological sample.

In a further aspect, in examples, all of the data and/or images collected by the assessment platform 304 may be used to train one or more machine learning models of the assessment platform 304 using data associated images of samples that share a characteristic with captured images of samples. In one example, the machine learning model may be trained using training data that shares a characteristic with a fluid sample to be analyzed by the microscopy analyzer 302. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model. For example, if a user is attempting to develop assays and microscopic analysis of blood samples to determine blood cell count, the machine learning model may be trained by inputting images of blood samples with known blood cell counts, predicting, by the machine learning model, a blood cell count of one or more training images, comparing the predicted blood cell count to the known blood cell count, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

The training data may include images of dry samples, images of fluid samples, images of mixed fluid samples including biological samples and a stain configured to react in an aqueous solution, images of blank slides, synthetic, augmented images, or any combination thereof. In a further aspect, in examples, one or more naturally occurring samples may be added to the prepared sample so that both have abnormal characteristics (i.e., a “spiked sample”), which may include adding parasites, such as bacteria, to the sample or separating specific cells and/or analyzing them as a purified sample and/or integrated into another sample to add one or more particular cells and/or features to the prepared sample prior to analysis. Other examples are possible.

In some examples, the machine learning model of assessment platform 304 may be adjusted based on training such that if the outcome of a determined condition matches the characteristic of the training images, the machine learning model is reinforced and if the outcome of a determined condition does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Furthermore, in example embodiments, as the one or more machine learning models are trained, over time, the capabilities of these models to identify the one or more characteristics of the captured images (and/or the cells or cell types in the image) will improve. These improvements may allow the one or more machine learning models to perform this analysis faster and with less computational burden. In examples, these one or more machine learning models may be executed at the microscopy analyzer 302 prior to transmission to the assessment platform 304. In doing so, in examples, microscopy analyzer 302 may be used to identify the one or more characteristics of the captured images (and/or the cells or cell types in the image) prior to transmission to the assessment platform 304, and only transmit the portions and/or subset of the captured images that are relevant to the analysis and/or training protocols at the assessment platform 304. In a further aspect, the microscopy analyzer 302 may also use one or more components to encrypt and/or compress these portions and/or subsets of the captured images prior to transmission to the assessment platform 304. Other examples are possible.

In some embodiments, the assessment platform 304 may determine that a plurality of images received from the microscopy analyzer 302 need to be retaken and/or re-uploaded to the assessment platform 304 for further analysis. In response, the assessment platform 304 may transmit one or more instructions (e.g., to the mobile computing device 306 or to the microscopy analyzer 302) to recapture the images. In some examples, the assessment platform 304 determines an image enhancement for one or more captured images, applies the image enhancement to the one or more images, and outputs, to the mobile computing device 306, the one or more enhanced images. In one example, a user may instruct the assessment platform 304 by an instruction executed from the mobile computing device 306 to apply image enhancements to the one or more images. In some examples, the image enhancements include saturation enhancement, brightness enhancement, contrast enhancement, a focal setting enhancement, size enhancement (such as image cropping), or any combination thereof.

Once the assessment platform 304 has determined a characteristic of a sample in one or more images, the assessment platform 304 may transmit instructions that cause a computing device (e.g., the mobile computing device 306) to display one or more graphical indications of the identified characteristic and/or the enhanced image.

Other computational actions, displayed graphical indications, alerts, and configurations are possible.

These example graphical user interfaces are merely for purposes of illustration. The features described herein may involve graphical user interfaces that are configured or formatted differently, include more or less information and/or additional or fewer instructions, include different types of information and/or instructions, and relate to one another in different ways.

### Example Methods and Aspects

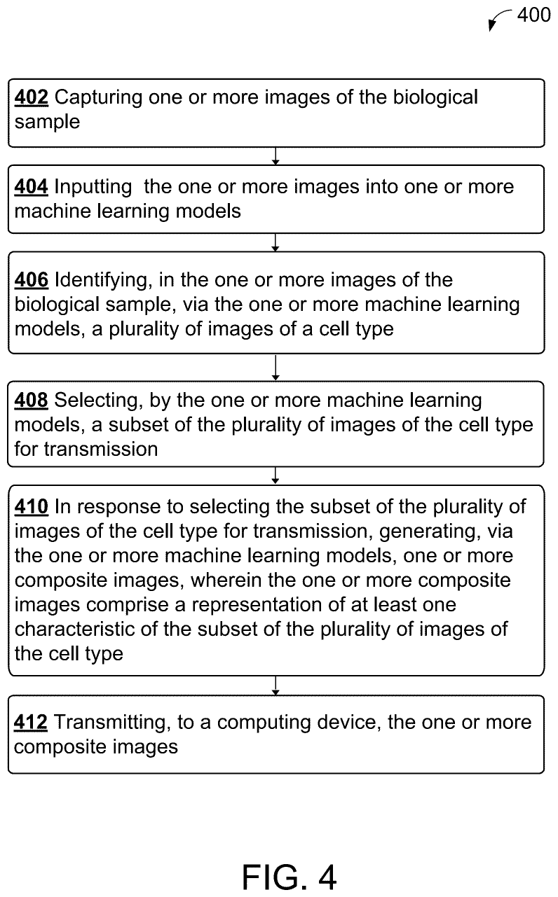

Now referring to FIG. 4, an example method of interrogating a sample. Method 400 shown in FIG. 4 presents an example of a computer-implemented method that could be used with the components shown in FIGS. 1-3, for example. Further, devices or systems may be used or configured to perform logical functions presented in FIG. 4. In other examples, components of the devices and/or systems may be arranged to be adapted to, capable of, or suited for performing the functions, such as when operated in a specific manner. Method 400 may include one or more operations, functions, or actions as illustrated by one or more of blocks 402-414. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 402, method 400 for interrogating a biological sample includes capturing one or more images of the biological sample. In some examples, capturing one or more images includes images captured from a camera, a thermal imager, photodiode sensors, or any combination thereof. In some examples, the sample includes a biological sample, including one or more of blood, urine, saliva, ear wax, fine needle aspirates, lavage fluids, body cavity fluids, or fecal matter. In some examples, capturing one or more images includes images captured using one or more partial fields of view of the biological sample, one or more focal lens ranges, and one or more light sources. In some examples, the one or more light sources of the microscopy device includes a brightfield light source and a fluorescent light source.

At block 404, method 400 involves inputting the one or more images into one or more machine learning models.

In some examples, the one or more machine learning models includes one or more of (i) an artificial neural network, (ii) a support vector machine, (iii) a regression tree, or (iv) an ensemble of regression tress.

In some examples, method 400 further includes, prior to inputting the one or more images into the one or more machine learning models, training the one or more machine learning models with one or more training images that share the characteristic with the one or more images.

In some examples, method 400 further includes, wherein training the one or more machine learning models comprises, based on inputting the one or more training images into the machine learning model, (i) predicting, by the one or more machine learning models, an outcome of a determined condition of the one or more training images, (ii) comparing the at least one outcome to the characteristic of the one or more training images, and (iii) adjusting, based on the comparison, the machine learning model.

In some examples, training the one or more machine learning models includes one or more of supervised learning, semi-supervised learning, reinforcement learning, or unsupervised learning.

At block 406, method 400 involves, identifying, in the one or more images of the biological sample, via the one or more machine learning models, a plurality of images of a cell type of the biological sample.

In some examples, identifying, in the one or more images of the biological sample, via the one or more machine learning models, a plurality of images of a cell type further includes identifying images of a first cell type and images of a second cell type. In such examples, method 400 may further include selecting a first subset of the first plurality of images of the first cell type and a second subset of the second plurality of images of the second cell type for transmission, and, in response to selecting the first subset of the images and the second subset of the images for transmission, generating, via the one or more machine learning models, a first composite image and a second composite image.

At block 408, method 400 involves selecting, by the one or more machine learning models, a subset of the plurality of images of the cell type for transmission.

In some examples, selecting, by the one or more machine learning models, a subset of the plurality of images of the cell type for transmission includes identifying clusters of the one or more images that have one or more similar characteristics, the similar characters including at least one of a determined cell size, a determined cell ratio, and a determined intensity of the cells.

At block 410, method 400 further involves, in response to selecting the subset of the plurality of images of the cell type for transmission, generating, via the one or more machine learning models, one or more composite images, wherein the one or more composite images comprise a representation of at least one characteristic of the subset of the plurality of images of the cell type.

In some examples, the one or more composite images comprises one or more mosaic images.

In some examples, generating the one or more composite images comprises overlaying the one or more images.

At block 412, method 400 further involves transmitting, to a computing device, the one or more composite images.

In some examples, transmitting, to a computing device, the one or more composite images comprises transmitting, to a computing device, instructions that cause a graphical user interface of the computing device to display the one or more composite images.

In some examples, identifying, in the one or more images of the biological sample, via the one or more machine learning models, a plurality of images of a cell type further comprises identifying images of a first cell type and images of a second cell type and method 400 further involves selecting a first subset of the images of the first cell type and a second subset of the images of the second cell type for transmission, in response to selecting the first subset of the images and the second subset of the images for transmission, generating, via the one or more machine learning models, a first composite image and a second composite image, and transmitting, to a computing device, the first composite image and the second composite image.

In some examples, method 400 further involves determining, via the one or more machine learning models, a first partial field of view of the biological sample based on a first determined characteristic of the biological sample and a second partial field of view of the biological sample based on a second determined characteristic of the biological sample, and wherein capturing the one or more images comprises capturing one or more images of the first partial field of view of the biological sample and one or more images of the second partial field of view of the biological sample.

In some examples, method 400 further includes, wherein generating, via the one or more machine learning models, one or more composite images comprises compiling the one or more images of the first partial field of view of the biological sample and the one or more images of the second partial field of view of the biological sample.

In some examples, method 400 further includes one or more composite images comprises 5×5 cells.

In some examples, method 400 further includes calculating, via the one or more machine learning models, statistical data of the subset of images of the cell type of the biological sample, and transmitting the statistical data. In some examples, prior to transmitting the one or more composite images and the statistical data, method 400 further includes encrypting the one or more composite images and the statistical data.

In another example, a non-transitory computer-readable medium is described, having instructions stored thereon, wherein the instructions, when executed by one or more processors, cause the one or more processors to perform a set of operations. The set of operations comprises capturing, by a microscopy device, one or more images of a biological sample. The set of instructions also comprises inputting the one or more images into one or more machine learning models and identifying, in the one or more images of the biological sample, via the one or more machine learning models, a plurality of images of a cell type. The set of instructions further comprises selecting, by the one or more machine learning models, a subset of the plurality of images of the cell type for transmission. The set of instructions also comprises, in response to selecting the subset of the plurality of images of the cell type for transmission, generating, via the one or more machine learning models, one or more composite images, wherein the one or more composite images comprise a representation of at least one characteristic of the subset of the plurality of the images of the cell type, and transmitting, to a computing device, the composite image.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

We claim:

1. A computer-implemented method for interrogating a biological sample, the computer-implemented method comprising:
capturing one or more images of the biological sample;
inputting the one or more images into one or more machine learning models;
identifying, in the one or more images of the biological sample, via the one or more machine learning models, a plurality of images of a cell type;
selecting, by the one or more machine learning models, a subset of the plurality of images of the cell type for transmission;
in response to selecting the subset of the plurality of images of the cell type for transmission, generating, via the one or more machine learning models, one or more composite images, wherein the one or more composite images comprise a representation of at least one characteristic of the subset of the plurality of images of the cell type; and
transmitting, to a computing device, the one or more composite images.

2. The computer-implemented method of claim 1, wherein the one or more composite images comprises one or more mosaic images.

3. The computer-implemented method of claim 1, wherein capturing one or more images of the biological sample comprises capturing, via a microscopy analyzer, one or more images of the biological sample.

4. The computer-implemented method of claim 1, wherein transmitting, to a computing device, the one or more composite images comprises transmitting, to a computing device, instructions that cause a graphical user interface of the computing device to display the one or more composite images.

5. The computer-implemented method of claim 1, wherein identifying, in the one or more images of the biological sample, via the one or more machine learning models, a plurality of images of a cell type further comprises identifying images of a first cell type and images of a second cell type, the computer-implemented method further comprising:
selecting a first subset of the images of the first cell type and a second subset of the images of the second cell type for transmission;
in response to selecting the first subset of the images and the second subset of the images for transmission, generating, via the one or more machine learning models, a first composite image and a second composite image; and
transmitting, to a computing device, the first composite image and the second composite image.

6. The computer-implemented method of claim 1, wherein the biological sample comprises one or more of the following: (i) blood; (ii) urine; (iii) saliva; (iv) ear wax; (v) fine needle aspirates; (vi) lavage fluids; (vii) body cavity fluids; and (viii) fecal matter.

7. The computer-implemented method of claim 1, wherein the one or more machine learning models comprise one or more of the following: (i) an artificial neural network, (ii) a support vector machine, (iii) a regression tree, or (iv) an ensemble of regression trees.

8. The computer-implemented method of claim 1, wherein selecting the subset of the images of the cell type comprises identifying clusters of the one or more images that have one or more similar characteristics, the similar characters including at least one of a determined cell size, a determined cell ratio, and a determined intensity of the cells.

9. The computer-implemented method of claim 1, further comprising:
determining, via the one or more machine learning models, a first partial field of view of the biological sample based on a first determined characteristic of the biological sample and a second partial field of view of the biological sample based on a second determined characteristic of the biological, and wherein capturing the one or more images comprises capturing one or more images of the first partial field of view of the biological sample and one or more images of the second partial field of view of the biological sample.

10. The computer-implemented method of claim 9, wherein generating, via the one or more machine learning models, one or more composite images comprises compiling the one or more images of the first partial field of view of the biological sample and the one or more images of the second partial field of view of the biological sample.

11. The computer-implemented method of claim 1, wherein the one or more composite images comprise 5×5 cells.

12. The computer-implemented method of claim 1, wherein capturing the one or more images comprises capturing using at least one of a florescent light source and a brightfield light source.

13. The computer-implemented method of claim 8, wherein creating the one or more composite images comprises overlaying the one or more images.

14. The computer-implemented method of claim 1, wherein capturing the one or more images comprises capturing images at one or more focal setting of an objective lens of a microscopy analyzer.

15. The computer-implemented method of claim 1, wherein training the one or more machine learning models comprises, based on inputting one or more training images into the one or more machine learning models: (i) predicting, by the one or more machine learning model, at least one outcome of a determined condition of the one or more training images; (ii) comparing the at least one outcome to the characteristic of the one or more training images; and (iii) adjusting, based on the comparison, the one or more machine learning models.

16. The computer-implemented method of claim 1, wherein training the one or more machine learning models comprises one or more of supervised learning, semi-supervised learning, reinforcement learning, or unsupervised learning.

17. The computer-implemented method of claim 1, further comprising, transmitting the one or more images to a data storage.

18. The computer-implemented method of claim 1, further comprising, calculating, via the one or more machine learning models, statistical data of the subset of images of the cell type of the biological sample, and transmitting the statistical data.

19. The computer-implemented method of claim 18, further comprising, prior to transmitting the one or more composite images and the statistical data, encrypting the one or more composite images and the statistical data.

20. A non-transitory, computer-readable medium having instructions stored thereon, wherein the instructions, when executed by one or more processors, cause the one or more processors to perform a set of operations comprising:
capturing one or more images of a biological sample;
inputting the one or more images into one or more machine learning models;
identifying, in the one or more images of the biological sample, via the one or more machine learning models, a plurality of images of a cell type;
selecting, by the one or more machine learning models, a subset of the plurality of images of the cell type for transmission;
in response to selecting the subset of the plurality of images of the cell type for transmission, generating, via the one or more machine learning models, one or more composite images, wherein the one or more composite images comprise a representation of at least one characteristic of the subset of the plurality of images of the cell type; and
transmitting, to a computing device, the composite image.
